(19) United States
(12) Patent Application Publication
(10) Pub. No.: US 2022/0379439 A1
(43) Pub. Date: Dec. 1, 2022

(54) Socket and Tool Assembly

(71) Applicant: KABO Tool Company, Taichung City (TW)

(72) Inventor: Chih-Ching Hsieh, Taichung City (TW)

(21) Appl. No.: 17/663,521

(22) Filed: May 16, 2022

(30) Foreign Application Priority Data
May 27, 2021 (TW) 110119194

(51) Int. Cl. B25B 13/06; B25B 23/00

(52) U.S. Cl. CPC B25B 13/065; B25B 23/0035

(57) ABSTRACT

A socket includes a socket body, a teeth structure, and a stopping structure and is engageable with a tool member. The socket body has an opening and an inner wall. The teeth structure is disposed on, and along the circumference of, the inner wall of the socket body and includes alternating inner teeth and concave portions. The stopping structure is disposed on, and along the circumference of, the inner wall of the socket body, is farther away from the opening than is the teeth structure, and includes a through hole and an inner surrounding wall. The through hole corresponds to the opening and is surrounded by the inner surrounding wall, which has a thickness. The distance from each concave portion to the hole wall surface of the through hole is defined as a stopping distance to be considered in relation to the thickness of the inner surrounding wall.

### BACKGROUND OF THE INVENTION

### 1. Technical Field

The present invention relates to a socket and more particularly to a socket having a stopping structure for abutting against a tool member.

### 2. Description of Related Art

With the advancement of technology, a tool member such as a screw can be operated with a socket engaged with the tool member in order to facilitate the operation. While being brought into engagement with the socket, however, the tool member may separate from the socket if the user exerts too great a force, thus causing a waste of time. To increase the stability with which a socket engages with a tool member, various accessories for use with sockets have been developed, but these accessories incur additional manufacturing cost.

In view of the above, it remains one of socket manufacturers' goals to develop a socket that can engage with a tool member more securely than the prior art but will not incur additional manufacturing cost.

### BRIEF SUMMARY OF THE INVENTION

One objective of the present invention is to provide a socket and a tool assembly. By providing the socket body with a stopping structure for abutting against a tool member inserted into the socket, the strength of engagement between the socket and the tool member is enhanced.

According to one embodiment of the present invention, a socket includes a socket body, a teeth structure, and a stopping structure. The socket body has an opening and an inner wall. The teeth structure is disposed on, and along the circumference of, the inner wall of the socket body and includes a plurality of inner teeth and a plurality of concave portions, wherein each concave portion is located between two adjacent inner teeth. The stopping structure is also disposed on, and along the circumference of, the inner wall of the socket body but is farther away from the opening than is the teeth structure. The stopping structure includes a through hole and an inner surrounding wall. The through hole corresponds to the opening. The inner surrounding wall has a thickness. The through hole is surrounded by the inner surrounding wall. The distance from each concave portion to the hole wall surface of the through hole is defined as a stopping distance to be considered in relation to the thickness of the inner surrounding wall.

When a tool member is inserted into the socket through the opening of the socket body, the tool member not only is engaged with the teeth structure, but also abuts against the stopping structure to increase the stress applied by the socket to the tool member, thereby enhancing the strength of engagement between the socket and the tool member.

The socket according to the foregoing embodiment may be so designed that the teeth structure further includes a groove, that the groove is disposed in, and along the circumference of, the teeth structure, and that the groove is located between the stopping structure and the opening.

The socket according to the foregoing embodiment may be so designed that the distance between the groove and the stopping structure is greater than the distance between the groove and the opening.

The socket according to the foregoing embodiment may be so designed that the socket further includes a retaining ring, that the retaining ring is disposed in the groove, and that the distance between the groove and the stopping structure is less than the distance between the groove and the opening.

The socket according to the foregoing embodiment may be so designed that each inner tooth of the teeth structure has a tooth height a, that the stopping distance is d2, and that the tooth height a and the stopping distance d2 satisfy the condition of 0.5≤d2/a≤2.

According to another embodiment of the present invention, a tool assembly includes a socket and a tool member. The socket includes a socket body, a teeth structure, and a stopping structure. The socket body has an opening and an inner wall. The teeth structure is disposed on, and along the circumference of, the inner wall of the socket body and includes a plurality of inner teeth and a plurality of concave portions, wherein each concave portion is located between two adjacent inner teeth. The stopping structure is also disposed on, and along the circumference of, the inner wall of the socket body but is farther away from the opening than is the teeth structure. The stopping structure includes a through hole and an inner surrounding wall. The through hole corresponds to the opening. The inner surrounding wall has a thickness. The through hole is surrounded by the inner surrounding wall. The distance from each concave portion to the hole wall surface of the through hole is defined as a stopping distance to be considered in relation to the thickness of the inner surrounding wall. The tool member includes an abutting portion, and the shape of the abutting portion corresponds to that of the teeth structure.

Once inserted into the socket, the tool member is engaged with the teeth structure, with the abutting portion abutting against the stopping structure to increase the area in which the socket engages with the tool member, thereby enhancing the strength of engagement between the socket and the tool member.

The tool assembly according to the foregoing embodiment may be so designed that the teeth structure further includes a groove, that the groove is disposed in, and along the circumference of, the teeth structure, and that the groove is located between the stopping structure and the opening.

The tool assembly according to the foregoing embodiment may be so designed that the socket further includes a retaining ring, that the retaining ring is disposed in the groove, and that the distance between the groove and the stopping structure is less than the distance between the groove and the opening.

The tool assembly according to the foregoing embodiment may be so designed that the teeth structure has a cross section with a first height h1, that the abutting portion has an abutting thickness A1, and that the first height h1 and the abutting thickness A1 satisfy the condition of h1≥A1.

The tool assembly according to the foregoing embodiment may be so designed that the tool member further includes a supporting portion, and that the shape of the supporting portion corresponds to that of the through hole of the stopping structure.

### BRIEF DESCRIPTION OF THE SEVERAL VIEWS OF THE DRAWINGS

FIG. 1 is a perspective view of the socket according to an embodiment of the present invention;

FIG. 2 is a front view of the socket according to the embodiment shown in FIG. 1;

FIG. 3 is a sectional view of the socket according to another embodiment of the invention;

FIG. 4 is a sectional view of the socket according to yet another embodiment of the invention;

FIG. 5 is an exploded view of the socket according to still another embodiment of the invention;

FIG. 6 is a sectional view of the socket according to the embodiment shown in FIG. 5; and

FIG. 7 is an exploded view of the tool assembly according to an embodiment of the invention.

### DETAILED DESCRIPTION OF THE INVENTION

A number of embodiments of the present invention will be described below with reference to the accompanying drawings. The following description will include many practical details in order to be clear and specific. The reader, however, should understand that those practical details are not intended to be restrictive of the scope of the invention; in other words, the practical details are not essential to some embodiments of the invention. Besides, for the sake of simplicity of the drawings, some conventional or commonly used structures and elements are drawn only schematically in the drawings, and repeated elements may be indicated by the same reference numeral or similar reference numerals.

In addition, when an element (or mechanism or module) is described herein as “connected to”, “disposed at”, or “coupled to” another element, the first element may be directly connected to, directly disposed at, or directly coupled to the second element, or the first element may be indirectly connected to, indirectly disposed at, or indirectly coupled to the second element, i.e., with another element between the first element and the second element. Only when it is explicitly stated that the first element is “directly connected to”, “directly disposed at”, or “directly coupled to” the second element will there be no other element between the first element and the second element. Furthermore, terms such as first, second, and third are used only to identify different elements or ingredients but not to limit the elements/ingredients themselves. It is therefore feasible to refer to the first element/ingredient as the second element/ingredient in stead. Moreover, the combination of elements/ingredients/mechanisms/modules disclosed herein is not a generally known, routine, or conventional combination in the field to which the invention pertains, so whether the combination relationship disclosed herein can be easily achieved by a person of ordinary skill in the art should not be determined by whether the elements/ingredients/mechanisms/modules themselves are conventional.

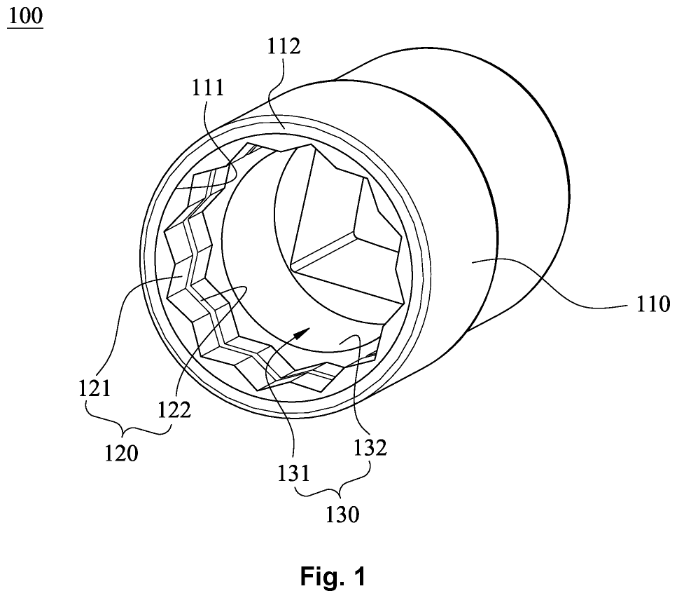

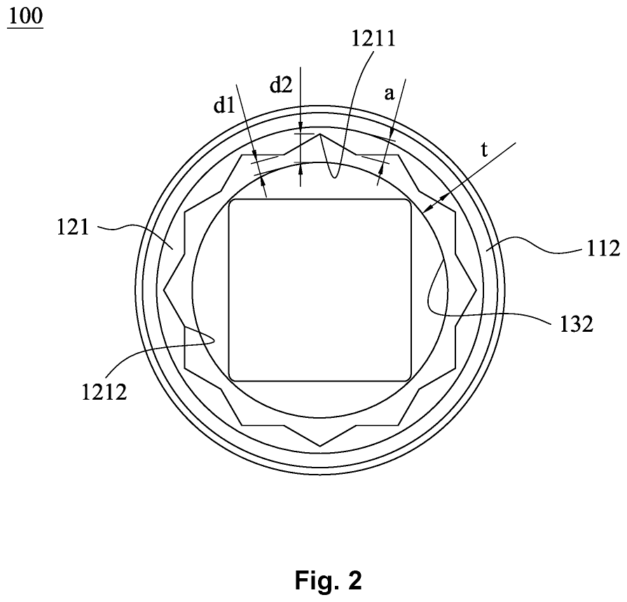

Please refer to FIG. 1 for a perspective view of the socket 100 according to an embodiment of the present invention. The socket 100 includes a socket body 110, a teeth structure 120, and a stopping structure 130. The socket body 110 has an opening 111 and an inner wall 112. The teeth structure 120 is disposed on, and along the circumference of, the inner wall 112 of the socket body 110 and includes a plurality of inner teeth 121 and a plurality of concave portions 1211 (see FIG. 2). The stopping structure 130 is also disposed on, and along the circumference of, the inner wall 112 of the socket body 110 but is farther away from the opening 111 than is the teeth structure 120. The stopping structure 130 includes a through hole 131 and an inner surrounding wall 132. The through hole 131 corresponds to the opening 111. The inner surrounding wall 132 has a thickness t (see FIG. 2). The through hole 131 is surrounded by the inner surrounding wall 132. The distance from each concave portion 1211 to the hole wall surface of the through hole 131 is defined as a stopping distance d2 (see FIG. 2) to be considered in relation to the thickness t of the inner surrounding wall 132. Once a tool member (not shown) is inserted into the socket 100 through the opening 111, the tool member is engaged with the teeth structure 120. Moreover, the portion of the inner surrounding wall 132 that is exposed from the concave portions 1211 and thereby exposes part of the thickness t as the stopping distance d2 abuts against the tool member to prevent the tool member from separating from the socket body 110 should the user exert an exceedingly great force. The tool member in the embodiment shown in FIG. 1 may be, but is not limited to, a hex cap screw. The stopping structure 130 of the socket 100 helps increase the strength with which the socket 100 engages with the tool member, but since no extra element is required, no additional manufacturing cost will be incurred.

As shown in FIG. 1, the teeth structure 120 may further include a groove 122. The groove 122 is disposed in, and along the circumference of, the teeth structure 120 and is located between the stopping structure 130 and the opening 111. As a tool member may produce debris when worn and damaged because of use, and the debris will reduce the friction between the tool member and the socket 100 and consequently the strength with which the socket 100 engages with the tool member, the groove 122 is provided so that while the tool member is being inserted into the socket 100, the inner teeth 121 not only engage with the tool member, but also can scrape the debris produced by the tool member into the groove 122, lest the debris be left on the tool member and reduce the friction between the tool member and the socket 100. Thus, the strength with which the socket 100 engages with the tool member is kept from being reduced.

Please refer to FIG. 2 for a front view of the socket 100 according to the embodiment shown in FIG. 1. As shown in FIG. 2, the through hole 131 of the stopping structure 130 is a circular through hole; the present invention, however, has no limitation on the shape of the through hole 131. In other embodiments, the through hole may be of a square, pentagonal, or other shape. That is to say, the shape of the stopping structure can be adjusted as needed.

As shown in FIG. 2, each inner tooth 121 of the teeth structure 120 has a tooth height a, the stopping distance from each concave portion 1211 to the hole wall surface of the through hole 131 is d2, and the tooth height a and the stopping distance d2 satisfy the condition of 0.5≤d2/a≤2. Moreover, each inner tooth 121 has a protruding end 1212. When 0.5≤d2/a≤1, the stopping distance d2 is less than or equal to the tooth height a of the inner teeth 121 (meaning the thickness t of the inner surrounding wall 132 does not exceed the height of the protruding ends 1212 of the inner teeth 121); thus, the manufacturing cost of the socket 100 can be reduced while the strength with which the socket 100 can engage with a tool member is effectively increased. When 1≤d2/a≤2, there is a distance d1 between each protruding end 1212 and the hole wall surface of the through hole 131, so the stability with which the stopping structure 130 engages with a tool member is enhanced.

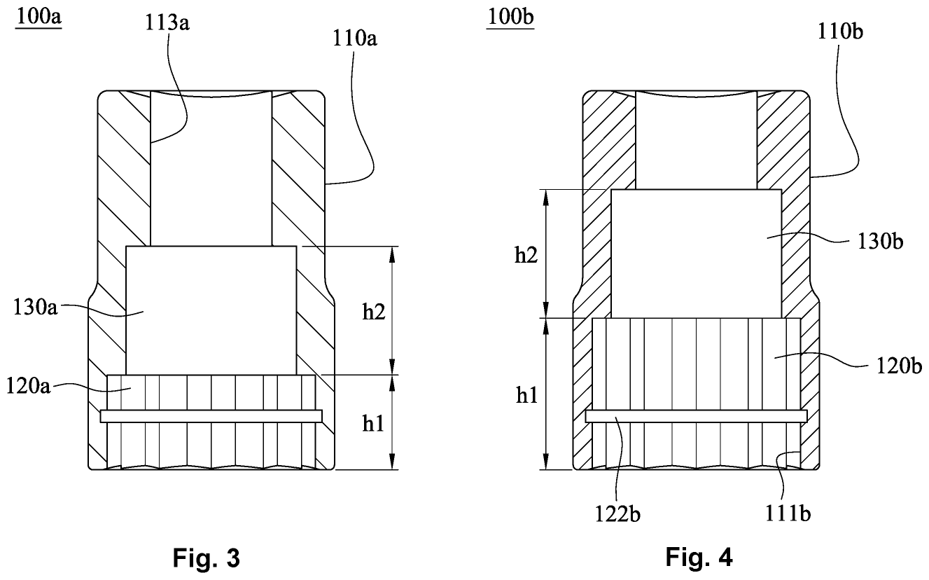

Please refer to FIG. 3 for a sectional view of the socket 100a according to another embodiment of the present invention. The socket 100a includes a socket body 110a, a teeth structure 120a, and a stopping structure 130a. The structures of the socket body 110a, the teeth structure 120a, and the stopping structure 130a in the embodiment shown in FIG. 3 are the same as those of the socket body 110, the teeth structure 120, and the stopping structure 130 in the embodiment shown in FIG. 1 and therefore will not be described repeatedly. What is special about the embodiment shown in FIG. 3 is that the socket body 110a includes a connection opening 113a for connecting a connection tool (not shown) to the socket 100a, wherein the connection tool may be, but is not limited to, a socket wrench.

The teeth structure 120a has a cross section with a first height h1, and the stopping structure 130a has a cross section with a second height h2. The second height h2 of the stopping structure 130a is greater than the first height h1 of the teeth structure 120a so that a connection tool subjected to too great an applied force is kept from entering the space surrounded by the teeth structure 120a through the connection opening 113a and hence from pushing a tool member out of the socket 100a.

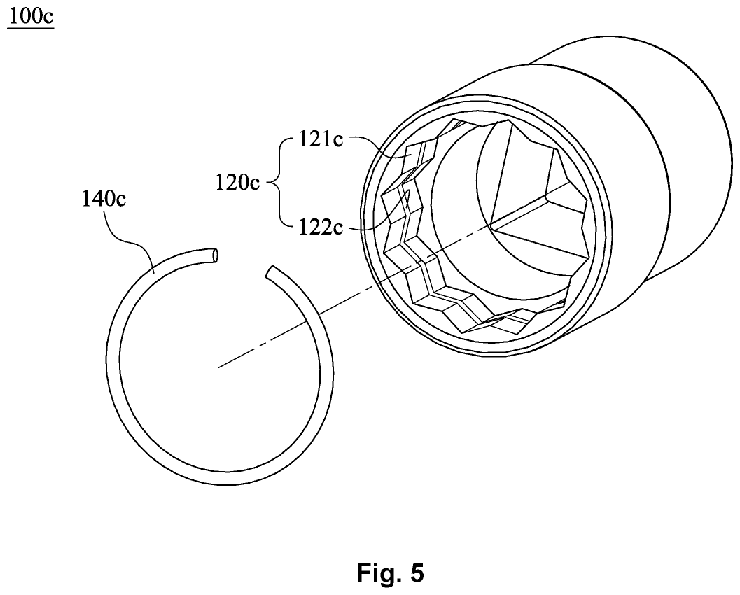

Please refer to FIG. 4 for a sectional view of the socket 100b according to yet another embodiment of the present invention. The socket 100b includes a socket body 110b, a teeth structure 120b, and a stopping structure 130b. In the embodiment shown in FIG. 4, the socket body 110b has an opening 111b and an inner wall (not indicated by a reference numeral in the drawing). The teeth structure 120b is disposed on, and along the circumference of, the inner wall of the socket body 110b and includes a plurality of inner teeth (not indicated by a reference numeral in the drawing) and a groove 122b. The groove 122b is disposed in, and along the circumference of, the teeth structure 120b and is located between the stopping structure 130b and the opening 111b. The stopping structure 130b in the embodiment shown in FIG. 4 is structurally the same as the stopping structure 130 in the embodiment shown in FIG. 1 and therefore will not be described at greater length.

What is special about the embodiment shown in FIG. 4 is that the teeth structure 120b has a cross section with a first height h1, that the stopping structure 130b has a cross section with a second height h2, and that the second height h2 of the stopping structure 130b is less than the first height h1 of the teeth structure 120b. In the embodiment shown in FIG. 4, the socket 100b can work with a tool member such as but not limited to a hex nut. More specifically, the first height h1 of the teeth structure 120b is greater than or equal to the nut thickness of the tool member so that the tool member can be sufficiently engaged with the teeth structure 120b to enhance the strength with which the socket 100b engages with the tool member.

As shown in FIG. 4, the distance between the groove 122b and the stopping structure 130b may be greater than the distance between the groove 122b and the opening 111b. When the groove 122b is closer to the opening 111b than to the stopping structure 130b, the inner teeth can scrape the debris on a tool member into the groove 122b as soon as the tool member is inserted into the socket 100b, and the debris that has been scraped into the groove 122b can be rapidly removed via the opening 111b after the tool member is removed from the socket 100b. Thus, the configuration shown in FIG. 4 allows the debris on a tool member to be scraped off rapidly.

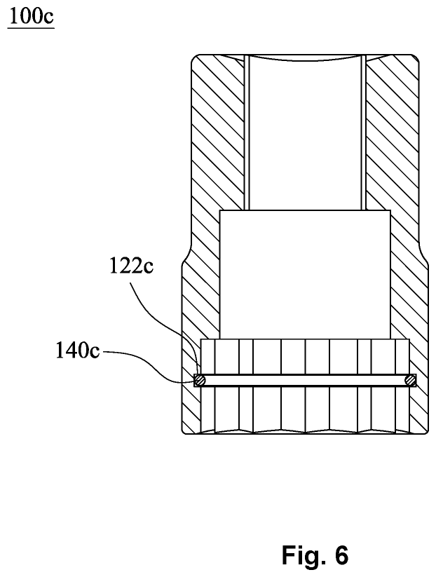

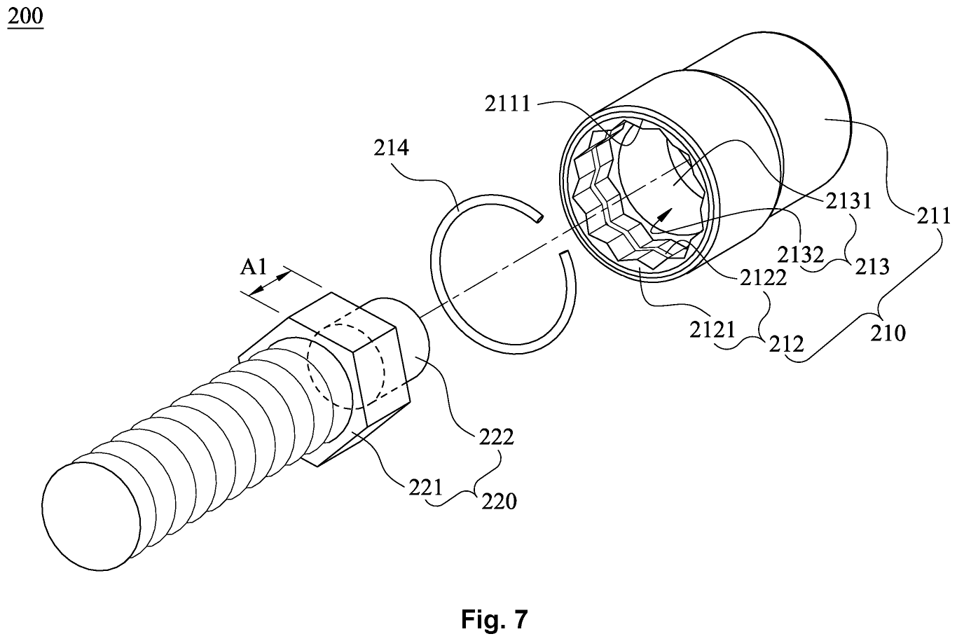

Please refer to FIG. 5 and FIG. 6 respectively for an exploded view of the socket 100c according to still another embodiment of the present invention and a sectional view of the socket 100c according to the embodiment shown in FIG. 5. As shown in FIG. 5 and FIG. 6, the socket 100c includes a socket body (not indicated by a reference numeral in the drawings), a teeth structure 120c, and a stopping structure (not indicated by a reference numeral in the drawings). The structures of the socket body and the stopping structure in the embodiment shown in FIG. 5 are the same as those of the socket body 110 and the stopping structure 130 in the embodiment shown in FIG. 1 and therefore will not be described repeatedly. The teeth structure 120c is disposed on, and along the circumference of, the inner wall of the socket body and includes a plurality of inner teeth 121c and a groove 122c. What is special about the embodiment shown in FIG. 5 is that the socket 100c further includes a retaining ring 140c. The retaining ring 140c is disposed in the groove 122c, and the distance between the groove 122c and the stopping structure is less than the distance between the groove 122c and the opening of the socket body.

More specifically, the retaining ring 140c is configured to retain a tool member (not shown), and the relatively small distance between the groove 122c and the stopping structure helps increase the retaining ability of the retaining ring 140c. In the embodiment shown in FIG. 5, the socket 100c can work with a tool member such as a screw with a nut. The retaining ring 140c and the stopping structure are so configured and arranged that the retaining ring 140c can retain the nut while the nut abuts against the stopping structure and is thus kept from moving away from the area in which it can be retained by the retaining ring 140c; consequently, the ability of the socket 100c to engage with the tool member is enhanced.

Please refer to FIG. 7 for an exploded view of the tool assembly 200 according to an embodiment of the present invention. The tool assembly 200 includes a socket 210 and a tool member 220. The socket 210 includes a socket body 211, a teeth structure 212, and a stopping structure 213. The socket body 211 has an opening 2111 and an inner wall (not indicated by a reference numeral in the drawing). The teeth structure 212 is disposed on, and along the circumference of, the inner wall of the socket body 211 and includes a plurality of inner teeth 2121, a plurality of concave portions (not indicated by a reference numeral in the drawing), and a groove 2122, wherein each concave portion is located between two adjacent inner teeth 2121. The stopping structure 213 is also disposed on, and along the circumference of, the inner wall of the socket body 211 but is farther away from the opening 2111 than is the teeth structure 212. The stopping structure 213 includes a through hole 2131 and an inner surrounding wall 2132. The through hole 2131 corresponds to the opening 2111. The inner surrounding wall 2132 has a thickness (not indicated by a reference numeral in the drawing). The through hole 2131 is surrounded by the inner surrounding wall 2132. The distance from each concave portion to the hole wall surface of the through hole 2131 is defined as a stopping distance (not indicated by a reference numeral in the drawing) to be considered in relation to the thickness of the inner surrounding wall 2132. The tool member 220 includes an abutting portion 221. The shape of the abutting portion 221 corresponds to that of the teeth structure 212.

More specifically, the abutting portion 221 of the tool member 220 can be engaged with the teeth structure 212 and abut against the stopping structure 213 such that the ability of the socket 210 to engage with the tool member 220 is enhanced.

In the embodiment shown in FIG. 7, the teeth structure 212 has a cross section with a first height h1 (not indicated in the drawing), the abutting portion 221 has an abutting thickness A1, and the first height h1 and the abutting thickness A1 satisfy the condition of h1≥A1. More specifically, in the embodiment shown in FIG. 7, h1=A1+2 mm. Thus, the stability with which the socket 210 engages with the tool member 220 is increased.

The tool member 220 may further include a supporting portion 222. The shape of the supporting portion 222 corresponds to that of the through hole 2131 of the stopping structure 213. The supporting portion 222 is configured to be engaged in the through hole 2131 such that the area in which the socket 210 engages with the tool member 220 is increased. This helps enhance the strength of engagement between the socket 210 and the tool member 220.

As shown in FIG. 7, the groove 2122 is disposed in, and along the circumference of, the teeth structure 212 and is located between the stopping structure 213 and the opening 2111. The socket 210 may further include a retaining ring 214. The retaining ring 214 is disposed in the groove 2122, and the distance between the groove 2122 and the stopping structure 213 is less than the distance between the groove 2122 and the opening 2111. In the embodiment shown in FIG. 7, the tool member 220 is a hex cap screw; the present invention, however, has no limitation in this regard. The retaining ring 214 and the groove 2122 are so configured and arranged that the retaining ring 214 can retain the abutting portion 221 while the abutting portion 221 abuts against the stopping structure 213 to enhance the strength of engagement between the socket 210 and the tool member 220.

The structures, relative positions, and other technical features of the teeth structures and stopping structures disclosed in the foregoing embodiments of the present invention can be combined as appropriate to meet the requirements of different sockets and thereby produce the corresponding effects. In other words, the invention is not limited to the disclosed embodiments.

According to the above, the socket and the tool assembly provided by the present invention have the following advantages: First, the stopping structure is configured to increase the strength with which the socket can engage with a/the tool member. Second, the groove in the teeth structure can prevent the debris produced by a/the tool member from reducing the strength with which the socket engages with the tool member. Third, a/the tool member may be provided with the supporting portion to enhance the strength of engagement between the socket and the tool member.

While the present invention has been disclosed through the embodiments described above, those embodiments are not intended to be restrictive of the scope of the invention. A person skilled in the art may change or modify the embodiments in various ways without departing from the spirit or scope of the invention. The scope of the patent protection sought by the applicant for the invention is defined by the appended claims.

What is claimed is:

1. A socket, comprising:
a socket body having an opening and an inner wall;
a teeth structure disposed on, and along a circumference of, the inner wall of the socket body, wherein the teeth structure comprises:
a plurality of inner teeth; and
a plurality of concave portions each located between two adjacent said inner teeth; and
a stopping structure disposed on, and along the circumference of, the inner wall of the socket body and being farther away from the opening than is the teeth structure, wherein the stopping structure comprises:
a through hole corresponding to the opening; and
an inner surrounding wall having a thickness, wherein the through hole is surrounded by the inner surrounding wall, and a distance from each said concave portion to a hole wall surface of the through hole is defined as a stopping distance to be considered in relation to the thickness of the inner surrounding wall.

2. The socket of claim 1, wherein the teeth structure further comprises:
a groove disposed in, and along a circumference of, the teeth structure, wherein the groove is located between the stopping structure and the opening.

3. The socket of claim 2, wherein a distance between the groove and the stopping structure is greater than a distance between the groove and the opening.

4. The socket of claim 2, further comprising:
a retaining ring disposed in the groove, wherein a distance between the groove and the stopping structure is less than a distance between the groove and the opening.

5. The socket of claim 1, wherein each said inner tooth of the teeth structure has a tooth height (a), and 0.5≤[the stopping distance (d2)/the tooth height (a)]≤2.

6. A tool assembly, comprising:
a socket comprising:
a socket body having an opening and an inner wall;
a teeth structure disposed on, and along a circumference of, the inner wall of the socket body, wherein the teeth structure comprises:
a plurality of inner teeth; and
a plurality of concave portions each located between two adjacent said inner teeth; and
a stopping structure disposed on, and along the circumference of, the inner wall of the socket body and being farther away from the opening than is the teeth structure, wherein the stopping structure comprises:
a through hole corresponding to the opening; and
an inner surrounding wall having a thickness, wherein the through hole is surrounded by the inner surrounding wall, and a distance from each said concave portion to a hole wall surface of the through hole is defined as a stopping distance to be considered in relation to the thickness of the inner surrounding wall; and
a tool member comprising:
an abutting portion corresponding in shape to the teeth structure.

7. The tool assembly of claim 6, wherein the teeth structure further comprises:
a groove disposed in, and along a circumference of, the teeth structure, wherein the groove is located between the stopping structure and the opening.

8. The tool assembly of claim 6, wherein the socket further comprises:
a retaining ring disposed in the groove, wherein a distance between the groove and the stopping structure is less than a distance between the groove and the opening.

9. The tool assembly of claim 6, wherein the teeth structure has a cross section with a first height (h1), the abutting portion has an abutting thickness (A1), and the first height (h1) is greater than or equal to the abutting thickness (A1).

10. The tool assembly of claim 6, wherein the tool member further comprises:
a supporting portion corresponding in shape to the through hole of the stopping structure.
